(19) United States
(12) Patent Application Publication
(10) Pub. No.: US 2014/0209146 A1
(43) Pub. Date: Jul. 31, 2014

(54) SOLAR POWER GENERATING APPARATUS

(71) Applicants: Gi Ju Park, Gwangju-si (KR); Doo Yeol Park, Incheon (KR); Gwang Jin Lee, Seoul (KR)

(72) Inventors: Gi Ju Park, Gwangju-si (KR); Doo Yeol Park, Incheon (KR); Gwang Jin Lee, Seoul (KR)

(73) Assignee: RAON TECH CO., LTD., Seoul (KR)

(21) Appl. No.: 14/240,699

(22) PCT Filed: Apr. 18, 2012
(86) PCT No.: PCT/KR2012/002956

§ 371 Date: Feb. 24, 2014

(30) Foreign Application Priority Data
Aug. 26, 2011 (KR) 10-2011-0085730
Aug. 26, 2011 (KR) 10-2011-0085733
Jan. 2, 2012 (KR) 10-2012-0000029

(51) Int. Cl. H01L 31/042

(52) U.S. Cl. CPC H02S 20/00
USPC 136/246; 136/251

(57) ABSTRACT

There is disclosed a photovoltaic power generation device that includes solar cell modules installed for solar cell panels, respectively, with forming a height difference or a gap between each two of the solar cell panels, to change an arrangement angle and direction of the solar cell modules for each season period according to variations of the sun altitude and azimuth.

### FIELD

The present invention may relate to a photovoltaic power generation device, more particularly, to a photovoltaic power generation device that is able to change an arrangement angle and an arrangement direction of a solar cell module according to an elevation angle (altitude) and direction of the sun.

### BACKGROUND

Recently, development of alternative energy sources is in progress as fossil fuel is being exhausted. Examples of such fossil fuel include petroleum, coal and the like. Especially, energy source development that uses a solar energy has been in progress briskly.

Examples of such power generation technology using the solar energy include solar power generation and photovoltaic power generation. The solar power generation generates electricity by driving a heat engine via a solar heat. The photovoltaic power generation generates electricity from a solar cell, using sunlight.

In this instance, the solar cell used in the photovoltaic power generation includes a semiconductor compound device configured to convert sunlight into electricity directly.

A conventional solar cell used in the photovoltaic power generation is typically formed of silicon and composite materials. Specifically, such a solar cell formed of junction between a P-type semiconductor and an N-type semiconductor and the solar cell uses the photoelectric effect of generating electricity after receiving sunlight.

Most of the conventional solar cells are formed of large area P-N junction diodes and an electromotive force generated from both ends of the P-N junction diode is connected to an external circuit board.

A minimum unit of such the solar cell is referenced to as ‘Cell’ and the cell of the solar cell is rarely used as it is.

Compared with several to hundreds of voltages (V) required to be actually used, the voltages generated from one cell is approximately 0.5V that is quite small. Because of that, a predetermined number of unit solar cells are connected in serial or parallel by a unit capacity.

In addition, in case they are used outdoor, the solar cells are subjected to harsh conditions. To protect the plurality of the cells connected by the unit capacity, the plurality of the cells forms a package and a solar cell module configured of cell packages is used.

However, a large amount of such solar cell modules have to be required to get a predetermined electric power and there is installation limit accordingly. In other words, there is no problem when the solar cell modules are installed in a roof of a building or an outdoor facility. It is difficult to install the solar cell modules in houses composing an apartment building, respectively, in case of installing them in one of apartment buildings that makes up a large part of houses.

In such the conventional solar cell module, solar cell panels connected with each other form a single large module. Accordingly, the conventional solar cell module might be damaged by the pressure of the wind generated by a typhoon accompanying a strong wind or the location influence and fail to disperse the pressure of the snow in a heavy snow fall region disadvantageously.

Moreover, a supporting structure for supporting the conventional solar cell module consists of main frames and supporters for supporting the solar cell module and a supporting column. The main frames, the supporters and the supporting columns are usually welded with each other. Once the welding finishes after their positions are determined, it is difficult to adjust the arrangement state.

Especially, an arrangement angle of a fixed-type supporting structure for supporting a plurality of solar cell modules is fixed and it is limited to adjust the arrangement angle of the solar cell modules according to the solar altitude changed by changing solar terms. Because of that, there are disadvantages of deteriorated collection efficiency and deteriorated power generation.

In other words, the meridian transit altitude of the sun for each season in consideration of the latitude (38°) of our country, Korea, is approximately 52° in the vernal or autumn equinox and 75.5° in the summer solstice and 28.5° in the winter solstice.

The conventional solar cell modules are installed at a fixed angle toward the south and it still has the limitation of wide variations in the amounts of electricity generation per for seasons.

Moreover, such the photovoltaic power generation device is installed in a place having sunlight from the sun rise to sun set continuously and examples of such a place include a roof and a top of a building or house positioned relatively high. Accordingly, the photovoltaic power generation device might be damaged or malfunctioned by a lightning disadvantageously.

### DETAILED DESCRIPTION OF THE INVENTION

### Technical Problem

To solve those disadvantages of damage to the solar cell modules and the supporting structure generated by the wind pressure or the snow pressure, an object of the invention is to provide a photovoltaic power generation device that includes solar cell modules installed for solar cell panels, respectively, with forming a height difference or a gap between each two of the solar cell panels, to change an arrangement angle and direction of the solar cell modules for each season period according to variations of the sun altitude and azimuth.

### Technical Solution

To achieve these objects and other advantages and in accordance with the purpose of the embodiments, as embodied and broadly described herein, a photovoltaic power generation device includes a supporting frame provided to make positions of a plurality of solar cell modules be adjustable; a first supporting unit provided under the supporting frame to dispersedly support a load of the supporting frame; a hinge connection unit coupled to a lower portion of the first supporting unit to relatively rotate the first supporting unit in a vertical direction; a horizontal driving unit provided in a lower portion of the hinge connection unit, the horizontal driving unit comprising a first driving motor configured to rotate the hinge connection unit from the ground in a horizontal direction; and a vertical driving unit comprising one end coupled to a lateral surface of the hinge connection unit and the other end coupled to a central portion of the first supporting unit.

The vertical driving unit may include a rotary member comprising one end coupled to the second driving motor to rotate together with the second driving motor, with a male screw formed in an outer circumferential surface thereof, formed in a longitudinal round bar shape; a transfer member comprising one end rotatably coupled the first supporting unit, with a female screw engaging with the rotary member to reciprocate forward and backward along the rotation of the rotary member; and a guide member comprising a lower portion of an outer circumferential surface thereof rotatably coupled to a predetermined portion of the hinge connection unit, to guide the reciprocation of the transfer member.

The transfer member may include at least one first bush coupled to an outer circumferential surface of the other end thereof to contact with an inner circumferential surface of the guide member to prevent a frictional force and noise.

The guide member may include a second bush provided in an inner circumferential surface of one end thereof to face the first bush during the reciprocation of the transfer member to guide a moving direction of the transfer member and to restrict separation of the transfer member.

The photovoltaic power generation device may further include a decelerator disposed between the second driving motor and the rotary member to control a rotational force of the rotary member.

The photovoltaic power generation device may further include a control unit configured to control the first driving motor and the second driving motor to adjust an azimuth and an altitude of the solar cell modules.

The control unit may detect weather information provided outside or from weather information detecting sensor provided therein and may control the first driving motor and the second driving motor based on the detected weather information.

The control unit may include a GPS module configured to receive a GPS signal from a satellite; a communication module configured to group the plurality of the solar cell modules as one group by using RS 485 communication and to transmit sensing signal of the solar cell modules; a weather module configured to receive the weather information acquired by the communication module or the GPS module and to analyze the weather information; and a control module configured to control the first driving motor and the second driving motor based on the information transmitted from the weather module.

The weather module may determine whether the information transmitted from the GPS module or the communication module is corresponding to a yellow dust mode, a typhoon mode, a snow mode or a seasonal wind mode and transmits the result of the determination to the control module.

The GPS module may acquire information on a position of the solar cell modules and information on the current time and weather information on the temperature, the humidity and winds and transmits the acquired information to the control module via the weather module.

The solar cell module may include a plurality of solar cell panels arranged thereon, and a fixing bracket fixing the solar cell panels to the supporting frame to make the height of one solar cell panel different from the height of another neighboring solar cell panel.

The solar cell panels may be arranged on the solar cell modules, with the height of one solar cell panel being different from the height of another solar cell arranged next to one solar cell panel in right/left and up/down directions.

The solar cell panels may be arranged to have the same height with the other solar cell panels arranged on the solar cell modules in zigzags.

The solar cell panels may be arranged to form a gap between one solar cell panel and another solar cell panel arranged next to one solar cell panel in right/left and up/down directions on the solar cell modules.

The photovoltaic power generation device may further include a lightening protection unit arranged in a predetermined position that is higher than a top surface of the solar cell module to prevent a lightening from damaging to the solar cell modules.

The lightening protection unit may be arranged in a predetermined portion of the solar cell module that is the highest portion, and the lightening protection unit may include a plurality of coupling members coupled to an outer portion of the supporting frame; a plurality of insulator members coupled to outer portions of the coupling members, respectively, the insulator members formed of an insulative material; an extended member extended to have a larger height than the top surface of the solar cell module; and a lightening inducement member formed of a metallic material inducing a lightening, the lightening inducement member connecting upper ends of the extended members with each other.

The insulator member may perform insulation between the coupling member and a lower end of the extended member and the insulation member may include a corrugation configured to increase a surface distance of an outer circumferential surface and to prevent an insulation strength from deteriorated by an contaminated surface.

### Advantageous Effects

The photovoltaic power generation device according to the embodiments has following advantageous effects. First, the plurality of the solar cell panels can disperse the pressure applied by winds or snow effectively.

Second, the supporting frame supporting the solar cell modules is supported by the first supporting unit and the second supporting unit. Accordingly, the deformation of the solar cell modules and frame generated by an external shock such as a strong wind can be prevented.

Third, a lightening is prevented from falling on the solar cell modules directly. Accordingly, damage to the solar cell modules can be prevented.

Finally, light collection efficiency and power generation efficiency of the solar cell modules based on the precise position detecting of the sun can be maximized.

### BRIEF DESCRIPTION OF THE DRAWINGS

FIG. 1 is a rear perspective diagram of a photovoltaic power generation device according to one embodiment of the present invention;

FIG. 2 is a side view of the photovoltaic power generation device shown in FIG. 1;

FIG. 3 is a front perspective diagram of a first embodiment of the photovoltaic power generation device according to the present invention;

FIG. 4 is a front perspective diagram of a second embodiment of the photovoltaic power generation device according to the present invention;

FIG. 5 is a front perspective diagram of a third embodiment of the photovoltaic power generation device according to the present invention;

FIG. 6 is a front perspective diagram of a fourth embodiment of the photovoltaic power generation device according to the present invention;

FIG. 7 is an exploded perspective diagram illustrating a lightening protection unit shown in FIG. 1;

FIG. 8 is a side view illustrating a vertical driving unit shown in FIG. 2;

FIG. 9 is an exploded perspective diagram illustrating the vertical driving unit shown in FIG. 3;

FIG. 10 is a block diagram schematically illustrating a control unit shown in FIG. 2; and

FIGS. 11 to 13 are side views illustrating an operational state of the photovoltaic power generation device shown in FIG. 1.

### BEST MODE

### Detailed Description

Referring to the accompanying drawings, an LED illumination apparatus according to one embodiment will be described in detail as follows. Reference may now be made in detail to specific embodiments, examples of which may be illustrated in the accompanying drawings. Wherever possible, same reference numbers may be used throughout the drawings to refer to the same or like parts.

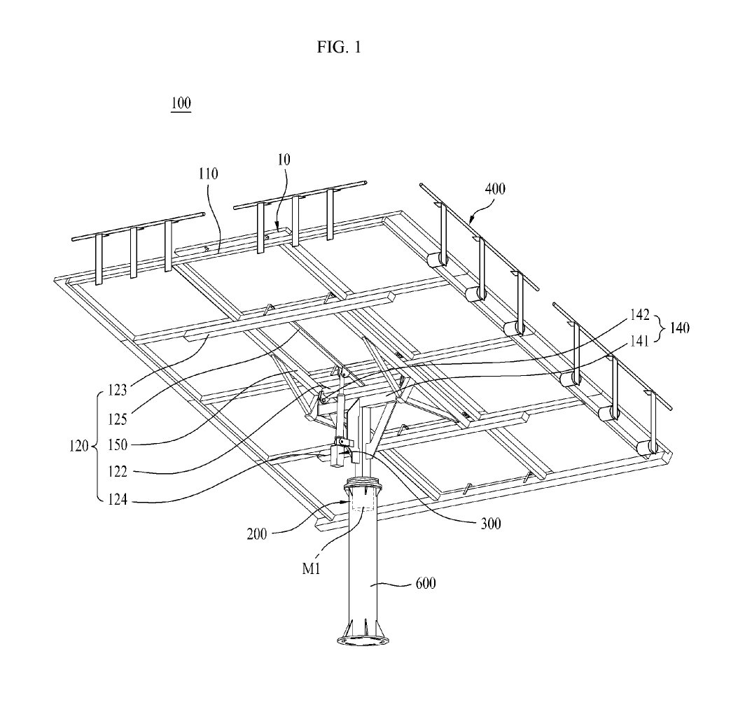

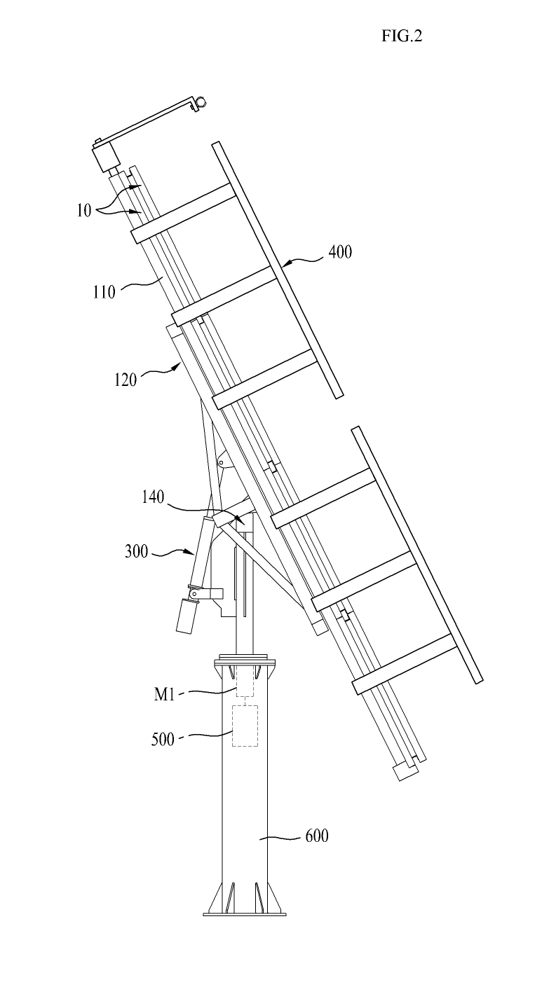

FIG. 1 is a rear perspective diagram of a photovoltaic power generation device 100 according to one embodiment of the present invention and FIG. 2 is a side view of the photovoltaic power generation device 100 shown in FIG. 1.

Referring to FIGS. 1 and 2, the photovoltaic power generation device 100 includes a supporting frame 110 provided to change connection positions of solar cell modules 10, a first supporting unit 120 provided under the supporting frame 110 to dispersedly support a load of the supporting frame 110, a hinge connection unit 140 connected to a lower portion of the first supporting unit 120 to relatively move in a vertical direction with respect to the first supporting unit 120, a horizontal driving unit 200 provided in a lower portion of the hinge connection unit 140 to horizontally rotate the hinge connection unit 140 from the ground, and a vertical driving unit 300 having an end coupled to a lateral side of the hinge connection unit 140 and the other end coupled to a central portion of the first supporting unit 120, to vertically rotate the supporting frame 110.

In addition, the photovoltaic power generation device 100 may include a lightening protection unit 400 arranged in a higher position than a top surface of the photovoltaic power generation device to prevent damage on the photovoltaic power generation device 100 from a lightening.

The photovoltaic power generation device 100 according to this embodiment of the present invention includes three solar cell modules 10 arranged horizontally and four solar cell modules 10 arranged vertically, such that a total of 12 sheets of the solar cell modules 10 may be provided, with an output of approximately 3 kW. The number of the solar cell modules 10 is related only to the overall capacity of the photovoltaic power generation and it is obvious that the arrangement and shape of the solar cell modules can be changed.

The overall width (horizontal length) is longer than the overall height (vertical length) of the solar cell modules 10 and the supporting frame 110 is assembled to have the vertical length corresponding to the size of the solar cell modules 10, with the horizontal length smaller than or the same as the horizontal length of the solar cell panel.

The supporting frame 110 is formed of a beam shape having a rectangular cross section and the size of the supporting frame 110 is determined based on the number of the solar cell modules 10. Also, the supporting frame 110 can be assembled to flexibly change the size thereof.

The plurality of the solar cell modules 10 may be arranged in a lattice pattern and spaced apart in a lateral direction to form a gap between each two neighboring solar cell modules to allow winds or snow to move there through.

Alternatively, the solar cell modules 10 may be arranged in zigzags and spaced apart to generate a difference between the heights of neighboring solar cell modules to allow winds or snow to move there through.

The lightening protection unit may be provided in an edge portion of the supporting frame 110. The lightening protection unit may be arranged higher than the top of the solar cell module 10 to prevent lightening from directly falling on the solar cell module 10.

At this time, the lightening protection unit may be provided only in an upper edge portion of the supporting frame 110 or in each edge portion of the supporting frame 110 in a position where the solar cell modules 10 are laid horizontally, to prevent the solar cell modules 10 from being damaged by the lightening.

The first supporting unit 120 coupled to a back surface of the supporting frame 110 includes a first horizontal frame 122 a pair of vertical frames 150 spaced apart a predetermined distance from each other in a vertical direction, a first horizontal frame 122 connected to a central portion of the vertical frame 150, a second horizontal frame 123 connected to both ends of the vertical frame 150, a third horizontal frame 124, and an auxiliary frame 125 connected to central portions of the first and second horizontal frames.

Two vertical frames 150 are formed in a hollow rectangular beam shape, spaced apart from each other in parallel. The vertical frames have to support the load of the supporting frame 110, the wind pressure and the load of the snow piled-up on the top of the solar cell module 10. Accordingly, the vertical frame is formed of a rigid material having a relatively large cross section area.

The first horizontal frame 122 is provided to connect central portions of the vertical frames 150 with each other and the first horizontal frame 122 has to support a large load. Accordingly, the first horizontal frame 122 is fabricated, considering various stresses applied thereto.

The second horizontal frame 123 and the third horizontal frame 124 are provided to connect one end with the other end of the vertical frame 150 and they support a less load, compared with the load the first horizontal frame 122 supports, such that it may be formed in a rectangular beam shape having a less cross section area.

The horizontal driving unit 200 is mounted in a body 600 supporting the ground and a first driving motor (M1) is provided in the horizontal driving unit 200. The first driving motor (M1) is connected to the hinge connection unit 140 such that the rotation of the first driving motor (M1) may adjust an azimuth.

The hinge connection unit 140 is provided under the first supporting unit 120 to rotatably connect the first supporting unit 120 thereto in a vertical direction.

The hinge connection unit 140 includes a hinge connection frame 141 hingedly coupled to a back surface of the first horizontal frame 122 and a plurality of coupling members 142 disposed on the back surface of the first horizontal frame 122 in a hinge coupling structure to dispersedly support the load of the first supporting unit 120.

The hinge coupling frame 141 generally supports the supporting frame 110 and the first supporting unit 120 and it is a portion where the largest load is applied. Accordingly, the size of the hinge coupling frame 141 may be relatively larger than the sizes of the supporting frame 110 and the first supporting unit 120.

The supporting frame 110 where the solar cell modules 10 are connected is tilted a predetermined angle with respect to the ground. The first supporting unit 120 may relatively move in a vertical direction with respect to the hinge coupling frame 141 arranged under the first supporting unit 120.

A duct groove (not shown) may be formed in the supporting frame 110 along a longitudinal direction with respect to the supporting frame 110 to make it easy to accommodate an electric wire exhausted from the solar cell module 110. One or more duct grooves may be formed in a lateral surface, top surface and a bottom surface of the supporting frame 110. It is preferred that the duct groove is formed in at least the bottom surface of the supporting frame 110, considering the arrangement structure and assemblage of the solar cell module 10.

A duct cap may be provided to prevent dust or rain from coming into the duct groove having the electric wire mounted therein. The duct cap may be slidingly or forcedly coupled to an end of the duct groove.

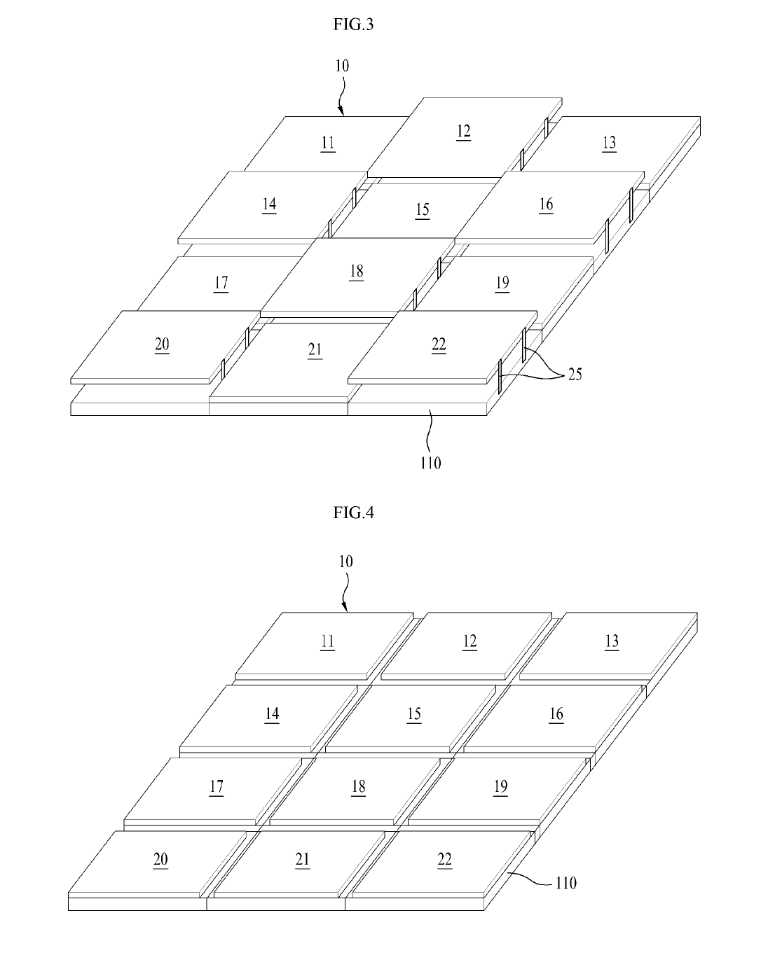

FIG. 3 is a front perspective diagram of a first embodiment of the photovoltaic power generation device according to the present invention.

As shown in FIG. 3, a photovoltaic power generation device according to this embodiment includes a first solar cell panel 11 to twelfth solar cell panel 22 arranged on the supporting frame 110.

The first solar cell panel 11 and the third solar cell panel 13 are coupled to an upper portion of the supporting frame 110 at the same height. The second solar cell 12 is fixed between the first and third solar cell panel 11 and 13 on the supporting frame 110, with a predetermined height. The fifth solar cell panel 15 is fixed on the supporting frame 110, with a predetermined height that is identical to the heights of the fourth solar cell 14 and the sixth solar cell panel 1, such that the height possessed by each of the solar cell panels positioned in zigzags is uniform.

Accordingly, it is preferred that the solar cell module 10 is installed to make the direction thereof be adjustable.

That is to prevent a shade generated by the height difference between the first solar cell panel 11 and the second solar cell panel 12 or the fourth solar cell panel 14.

In addition, air can flow through the gap formed by the height difference between the first solar cell panel 11 and the second solar cell panel 12, only to reduce the pressure applied to the solar cell module 10 by the wind pressure.

The gap is formed between each two neighboring solar cell panels such that foreign matters such as dust can be prevented from being piled up on the top surface of the solar cell panels and that damage to the solar cell panel generated by the load of the snow can be prevented when snow is piled up in the winter.

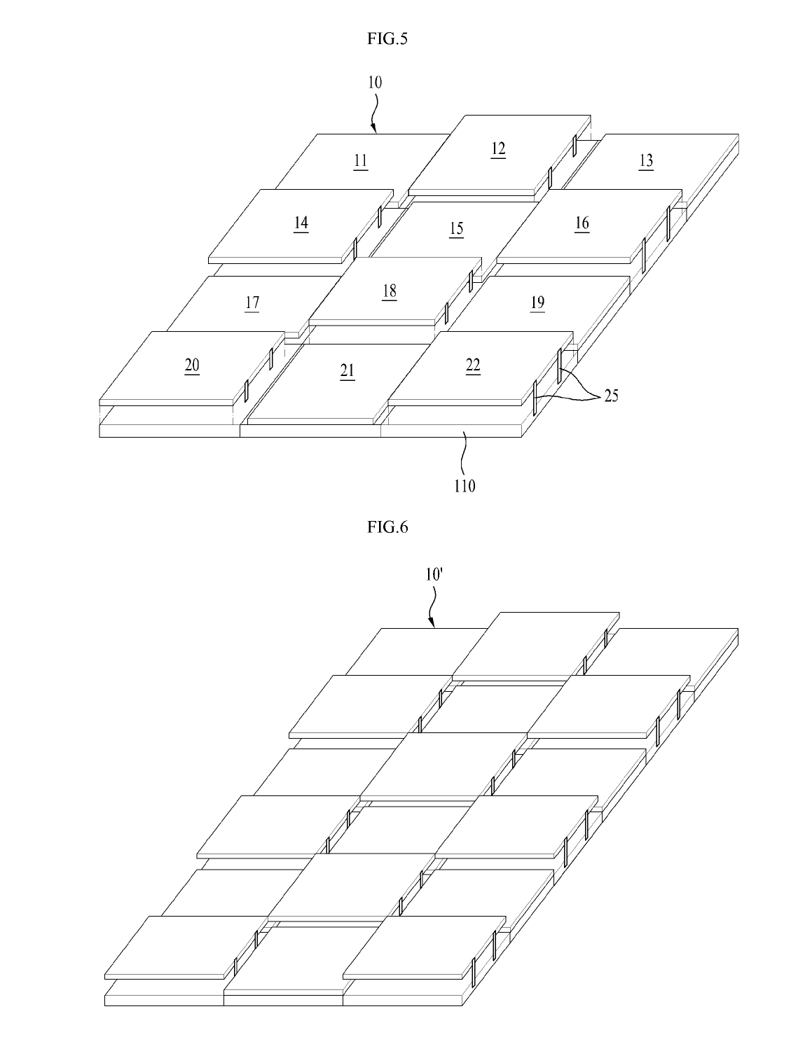

FIG. 4 is a front perspective diagram of a second embodiment of the photovoltaic power generation device according to the present invention.

As shown in FIG. 4, the first solar cell 11 to the twelfth solar cell 22 arranged on the solar cell module 10 are arranged apart a predetermined distance from each other in a lateral direction. The solar cell panels are spaced apart a predetermined distance from each other in up/down and right/left directions and the gaps may be formed between each two of the solar cell panels.

Accordingly, air can flow through the gaps formed between the solar cell panels and the damage to the solar cell panel generated by the wind pressure and snow load can be prevented.

FIG. 5 is a front perspective diagram of a third embodiment of the photovoltaic power generation device according to the present invention. As shown in FIG. 5, the first solar cell panel 11 to the sixth solar cell panel 22 are configured to have all of the characteristics possessed by the solar cell module 10 shown in FIGS. 3 and 4.

The second solar cell panel 12 is fixed by the fixing bracket 25 between the first solar cell panel 11 and the third solar cell panel 13, to have a predetermined height. The fourth solar cell panel 14 and the sixth solar cell panel 16 are fixed by the fixing bracket 25 to have a predetermined height in both sides of the fifth solar cell panel 15. Simultaneously, the solar cell panels are spaced apart a predetermined distance from each other in right/left and up/down directions.

In this instance, the effect using the height difference and the gap shown in FIGS. 3 and 4 can be achieved and results in an effect of minimized damage to the solar cell module generated by the wind pressure and the snow load.

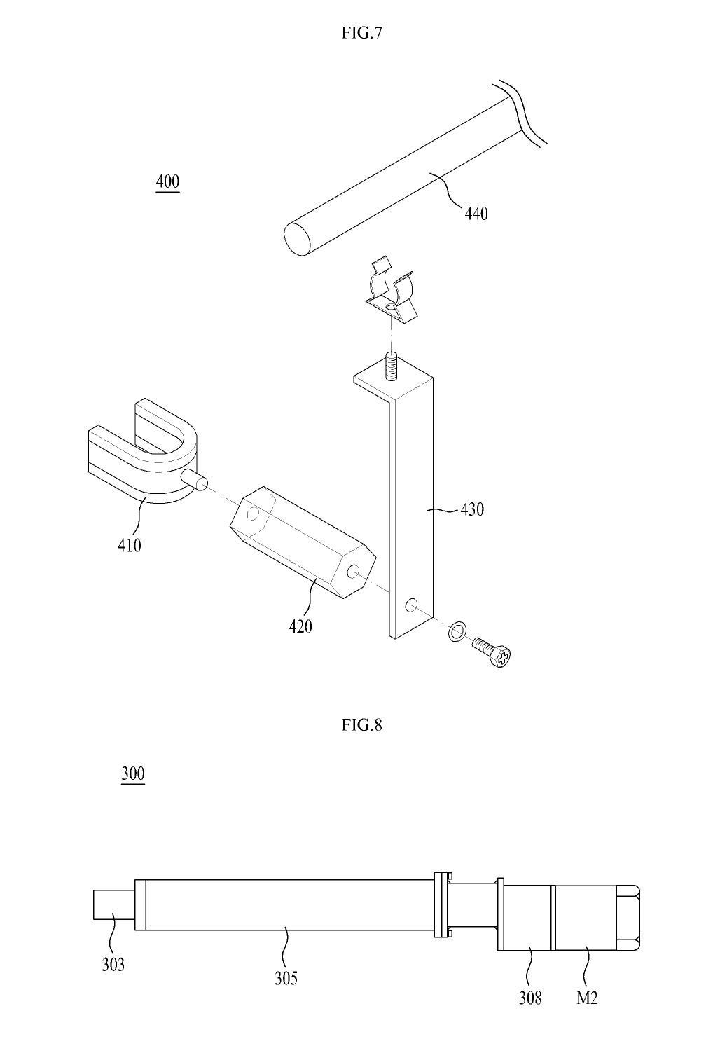

FIG. 6 is a front perspective diagram of a fourth embodiment of the photovoltaic power generation device according to the present invention.

As shown in FIG. 6, the solar cell panels can reduce the damage generated by the wind pressure and the snow load as much as possible and a solar cell module 10′ having 18 solar cell panels with large areas can be provided. In addition, a larger solar cell module can be fabricated. At this time, it is preferred that the solar cell module is installed to enable the direction of the solar cell module adjusted according to variations of the solar altitude as time passes, such that no shade can be generated on the solar cell panel by the difference between the heights of the solar cell panels.

FIG. 7 is an exploded perspective diagram illustrating a lightening protection unit 400 shown in FIG. 1.

Referring to FIG. 7, the lightening protection unit 400 is arranged in a predetermined position that is higher than the top surface of the solar cell module 10 to prevent a lightening from falling to the solar cell module 10 directly.

At this time, it is shown that lightening protection units 400 are provided beyond the top surface and lateral surface of the solar cell module 10. Alternatively, at least one lightening unit 400 may be provided one end positioned highest in the top surface of the solar cell module 10.

The lightening protection unit 400 includes a plurality of coupling members 410 coupled to the supporting frame (110, see FIG. 1), a plurality of insulator members 420 coupled to the coupling members 410 outwardly, extended members 430 coupled to the insulator members 420 outwardly and lightening inducement members 440 connected to upper ends of the extended members 430.

The coupling member 410 has a “U”-shaped cross section and it is coupled to an end of the supporting frame 110. Considering the tilted angle of the solar cell module 10, the coupling member 410 is perpendicularly coupled from each end of the supporting frame 110 with respect to the ground.

The insulator member 420 has one end coupled to the coupling member 410 and the other end coupled to the extended member 420, with an empty space formed therein to prevent electric current flow between the coupling member 410 and the extended member 430.

The insulator member 420 may be formed of porcelain, glass or plastic synthetic resin material and it may have an insulation function. One or more corrugations (not shown) may be formed in the insulator member 420 to have an electrically sufficient dielectric strength to increase a surface distance.

The corrugations formed in the insulator member 420 can be effective in preventing deteriorated dielectric strength when a surface humidity of the insulator member 420 is high, especially, when salt or dust is attached to the insulator member 420. It is preferred that the insulator member 420 is formed of hard ceramics having good corrosion resistance, heat resistance and rigidity.

The extended member 430 has one end coupled to the other end of the insulator member 420 and the other end bent to allow the lightening inducement member 440 coupled thereto. The extended member 430 can heighten the position of the lightening inducement member 440 from the insulator member 420 to arrange the inducement member 440 in a higher position than the top surface of the solar cell module 10. Accordingly, the safety of the solar cell module 10 can be secured from lightening advantageously.

The lightening inducement member 440 is provided to connect upper ends of the extended members 430 with each other. The lightening inducement member 440 and the extended member 430 are formed of metal to flow electric currents there between. At least one of the extended members 430 is grounding.

Accordingly, an electric shock applied to the supporting frame 110 by the lightening can be prevented from being transmitted to the solar cell module 10.

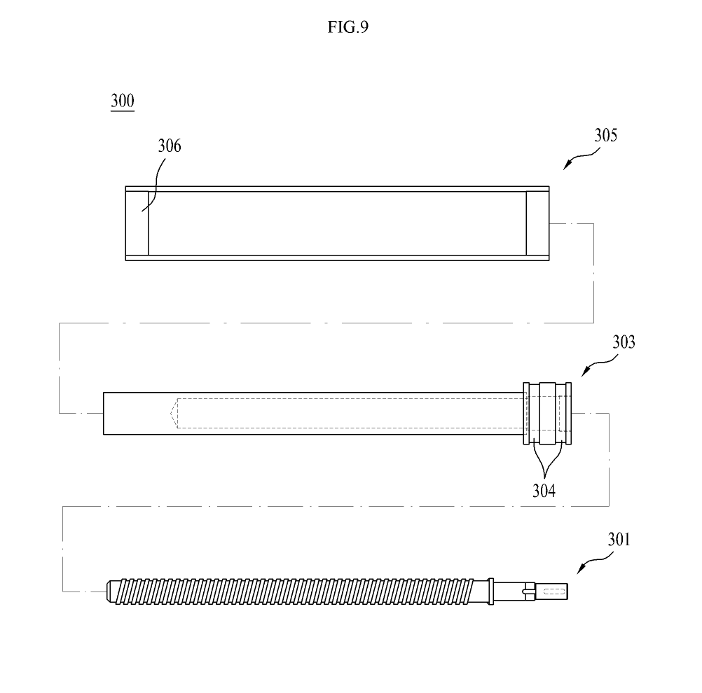

FIG. 8 is a side view illustrating a vertical driving unit shown in FIG. 2 and FIG. 9 is an exploded perspective diagram illustrating the vertical driving unit shown in FIG. 3.

Referring to FIGS. 8 and 9, the vertical driving unit 300 includes a rotary member 301 having one end connected with the second driving motor (M2) to rotate, with a male screw formed in an outer circumferential surface thereof, a transfer member 303 having a female screw formed in an inner circumferential surface thereof to engage with the rotary member 301, to reciprocate forward and backward along the rotational movement of rotary member 301, with an end rotatably coupled to the first supporting unit (120, see FIG. 1), and a guide member 305 formed in a cylindrical shape to guide the reciprocation of the transfer member 303, with a lower portion of an outer circumferential surface rotatably coupled to a predetermined portion of the hinge connection unit 140.

The transfer member 303 includes at least one first bush 304 fixed to an outer circumferential surface of the other end thereof to contact with an inner circumferential surface of the guide member 305 so as to prevent a frictional force and noise.

The guide member 305 includes a second bush 306 provided in an inner circumferential surface of one end thereof, in opposite to the first bush 304 when the transfer member 303 is reciprocating, to guide a moving direction of the transfer member 303 and to restrict the transfer member 303 from separating.

A decelerator 308 may be disposed between the second driving motor (M2) and the rotary member 301 to control the rotational force of the rotary member 301.

Once the rotary member 301 is rotated by the second driving motor (M2), the transfer member 303 engaging with the rotary member 301 may move forward and backward within the guide member 305. At this time, the first supporting unit 120 coupled to one end of the transfer member 303 may adjust altitude angle of the solar cell module 10 together with the supporting frame 110, only to control the altitude angle of the solar cell module according to positions of the sun.

As shown in FIG. 2, the case 600 may include a control unit 500 configured to control the first driving motor (M1) and the second driving motor (M2).

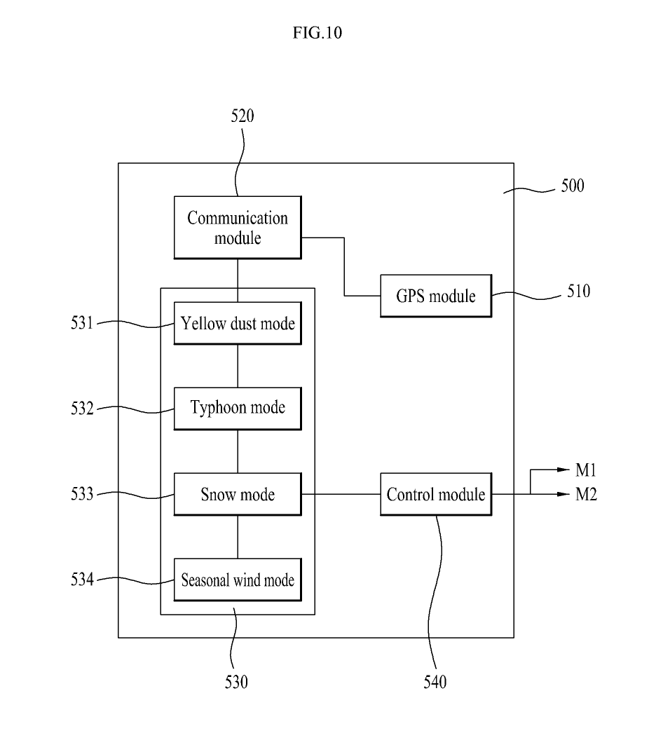

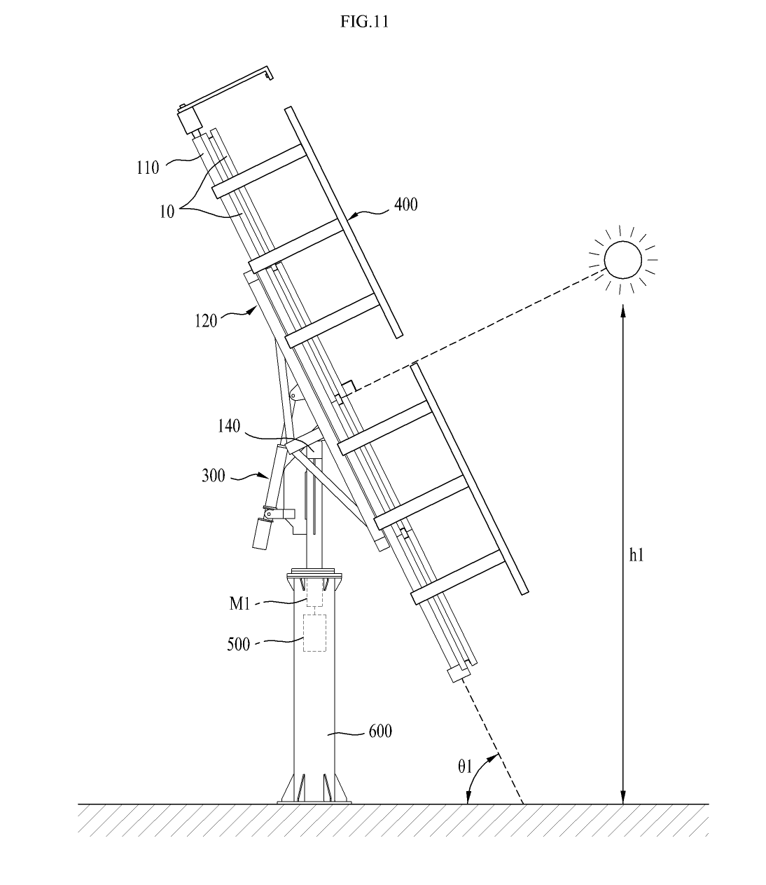

FIG. 10 is a block diagram schematically illustrating the control unit 500 shown in FIG. 2.

As shown in FIG. 10, the control unit 500 includes a GPS module 510, a communication module 520, a weather module 530 and a control module 540, and it controls the altitude angle and azimuth of the solar cell modules 10 by driving the first driving motor and the second driving motor.

Here, the weather module 531 is provided with the information acquired by the communication module 520 and the GPS module 510 and it determines whether the information is corresponding to a yellow dust mode 531, a typhoon mode 532, a snow mode 533 or a seasonal wind mode 534. The weather module 531 transmits the result of the determination to the control module 540.

The yellow dust mode 531 controls the direction of the solar cell modules to be on standby toward a southeast direction that is an opposite direction of a yellow dust blowing direction after finishing the power generation, provided for yellow dust generated in Mongolia in March to May.

In other words, when the yellow dust generated in Mongolia lies on a surface of the solar cell module 10, power generation efficiency can deteriorate as much as the yellow dust. Because of that, in case the amount of the yellow dust is a predetermined value or more, the direction of the solar cell modules 10 is changed into the reverse direction of the yellow dust blowing direction and then the yellow dust is prevented from lying on the surface of the solar cell module 10.

The typhoon mode 532 controls the solar cell modules 10 to be horizontal with respect to the ground and be on standby to minimize the influence of the wind pressure during the predetermined period in which typhoons are developing most often, for example, in July-September when 90% of typhoons hitting our country, Korea are formed.

In other words, to minimize damage to the photovoltaic power generation device 100 when a typhoon or strong wind is hitting, the typhoon mode 532 analyzes the information on a level of the typhoon or wind provided by the GPS module 510 or the communication module 520 and transmits the result of the analysis to the control module 540. The control module 540 controls the first driving motor and the second driving motor to make the solar cell modules 10 toward the sky, such that the damage generated by the typhoon or wind can be reduced as much as possible.

The snow mode 533 analyzes the information on snow provided by the GPS module 510 or the communication module 520 in advance and transmits the result of the analysis to the control module 520. The control module 520 controls the solar cell modules 10 to be perpendicular with respect to the ground, such that the damage generated by the snow can be reduced as much as possible.

In other words, when snow is piled up on the surface of the solar cell modules 10, the case 600 including the supporting frame 110 supporting the solar cell modules 10 could be damaged or broken by the load of the snow. Accordingly, the snow module 533 is provided with weather information on whether to snow or determines the snow in real-time and transmits the weather information or the result of the determination to the control module 540. The control module 540 controls the first driving motor and the second driving motor to make the solar cell modules 10 to be perpendicular with respect to the ground.

The seasonal wind mode 534 controls the solar cell modules 10 to be toward the east in eastern areas and toward the west in western areas in June when the summer starts, considering characteristics of seasonal winds blowing from the sea to the land because the temperature of the land is higher than that of the sea. The seasonal wind mode 534 controls the solar cell modules 10 to be toward the direction of the westerlies in which the solar cell modules 10 are affected least by the wind in October to December when waterlies are blowing from north-western Siberia because the temperature of the land is lower than that of the sea, considering characteristics of seasonal winds.

In addition, the seasonal wind mode 534 controls the first driving motor (M1, see FIG. 2) and the second driving motor (M2) to make the solar cell modules 10 be tilted, because the dews or snow piled up on the top surface of the module could affect the power generation, considering the influence of seasonal winds.

Here, the seasonal wind refers to hydrothermal circulation that makes winds blow toward the land from the sea in summer and toward the sea from the land in winter, because the heat capacity of the sea is larger than that of the land to make the land heated and chilled faster than the sea after the land is a low pressure area in summer because of its higher temperature and a high pressure area in winter because of its lower temperature.

Accordingly, the seasonal mode 534 controls the driving motor (M) to make the direction of the solar cell modules 10 be an optimal direction so as to prevent damage to the photovoltaic power generation device.

The photovoltaic power generation device 100 described above controls the control unit 500 additionally programmed to control the first driving motor and the second driving motor such that the direction of the solar cell modules 10 may be controlled to be the optimal direction according to the weather information.

Conventional trackers can implement tracker control only in a controller and a monitoring program. In case the photovoltaic installation capacity is relatively large, an installation area is increased and it is restricted to implement control only in the monitoring program. In addition, a control method implemented by a controller of the conventional tracker can implement control only in a place where a controller is installed. However, in the present invention, the azimuth and altitude angle of the solar cell modules 10 can be controlled freely via the typhoon mode, the yellow dust mode, the snow mode and the seasonal wind mode, such that the power generation efficiency may be enhanced and that damage to the photovoltaic power generation device can be prevented.

Here, the GPS module 510 receives a GPS signal from a satellite, in other words, it acquires weather information on the temperature, humidity and winds. The weather module 530 transmits the weather information to the control unit 540 and the GPS module 510 informs a user of the location of the photovoltaic power generation device 100 and of the current time in real time simultaneously.

The communication module 520 uses RS 485 communication in grouping approximately 15 photovoltaic power generation devices as one group and it receives sensing signals from the photovoltaic power generation device simultaneously. After that, the communication module 520 transmits the sensing signals to the control module 540 and the control module 540 controls each of the photovoltaic power generation devices identically. Meanwhile, group control can be implemented for each of groups.

Referring to the drawings, an operational effect of the photovoltaic power generation device 100 will be described in detail as follows.

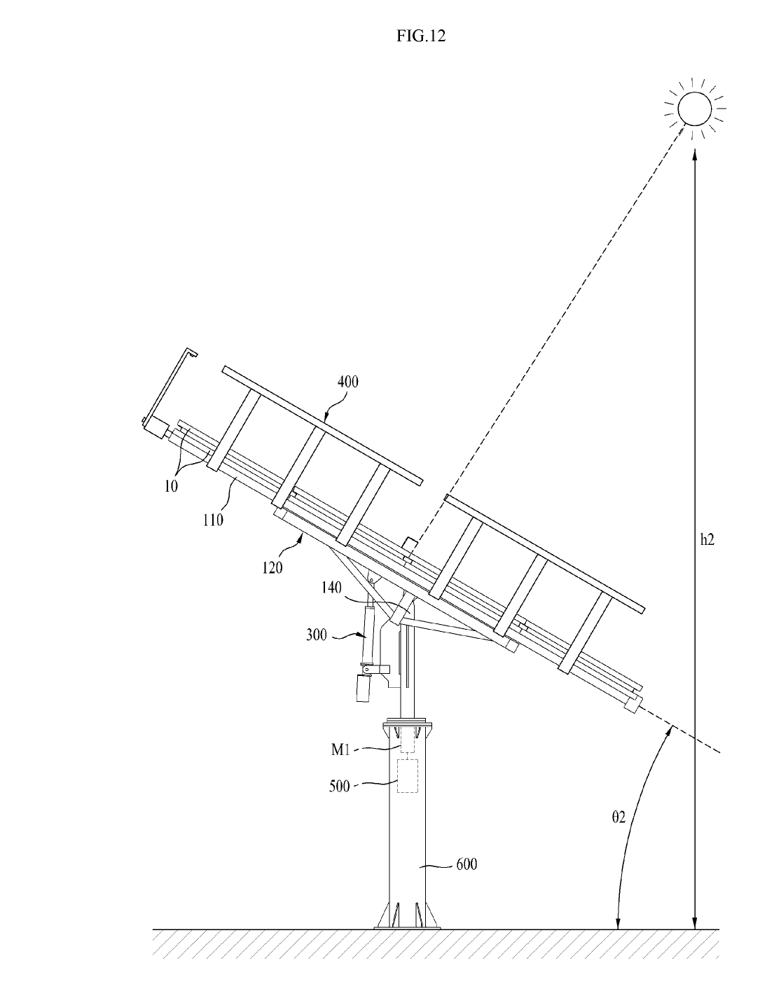

FIGS. 11 to 13 are side views illustrating an operational state of the photovoltaic power generation device shown in FIG. 1. The same references refer to the same elements as follows.

A line (L) connecting the surface of the solar cell modules 10 from the sun may be perpendicular to maximize light collection efficiency.

As shown in FIG. 11, the altitude (h1) of the sun is maintained the lowest at sunrise. In this instance, an arrangement angle (Θ1) of the solar cell module 10 is the most tilted angle with respect to the ground.

For that, one end of the transfer member (303, see FIG. 9) has to be withdrawn to push up the first supporting unit (120, see FIG. 1) as far as possible.

In this instance, the transfer member 303 is withdrawn from the vertical driving unit 300 upward as far as possible and the arrangement angle of the solar cell module 10 is the largest tilted angle.

At this time, the direction of the solar cell module 10 may be the eastern direction in which sunrise starts.

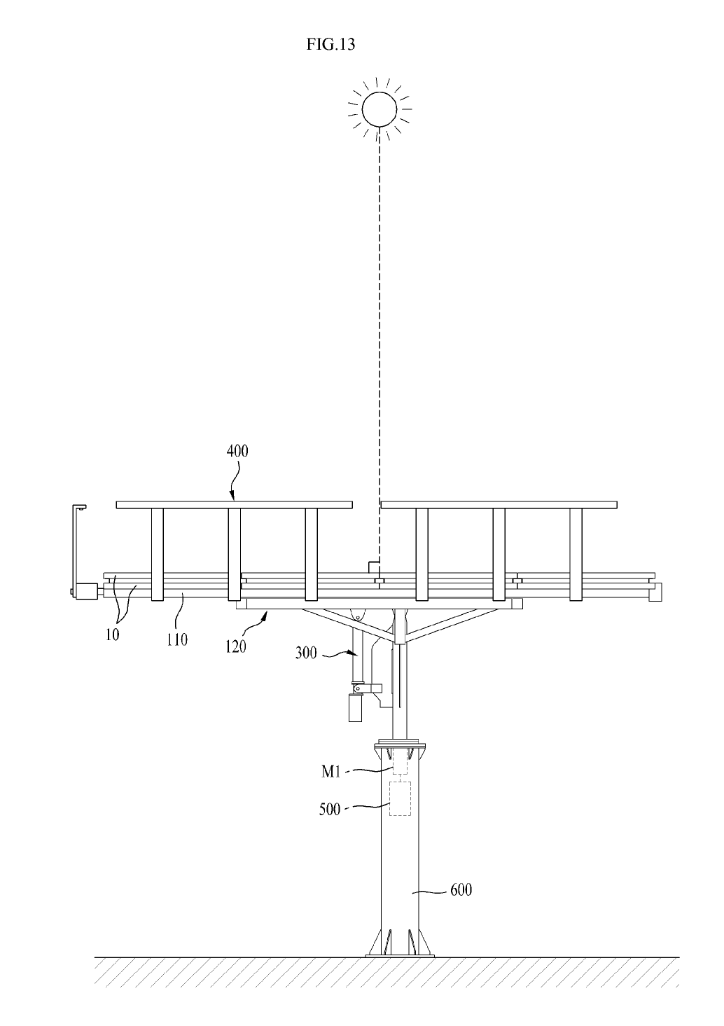

As shown in FIG. 12, the sun moves from the east to the southern east with the time and the altitude of the sun is heightened accordingly.

Reflecting the direction of the moving sun and variations of the altitude, the control unit (500, see FIG. 2) controls the first driving motor (M1) and the rotation of the first driving motor (M1) rotates the solar cell modules 10 toward the southeast.

Meanwhile, the transfer member 303 pulls the first supporting unit 120 and the altitude (h2) of the supporting frame is heightened together.

Once the transfer member 303 is pulled, the upper end of the solar cell module 10 is tilted back and the arrangement angle (Θ2) is a small tilted angle with respect to the ground, compared with the tilted angle shown in FIG. 11.

As shown in FIG. 13, when the sun reaches the highest altitude (h3) in process of time, the sun is positioned in the south.

At this time, the solar cell module 10 is rotated toward the south by the first driving motor (M1) and one of the transfer member 303 pulls the first supporting unit 120 as far as possible to make the angle of the supporting frame 110 be identical to the angle of the ground.

In this instance, the first supporting unit 120 coupled to one end of the transfer member 303 is pulled downward as far as possible and the arrangement angle of the solar cell module 10 is the smallest tilted angle.

Accordingly, the arrangement angle (Θ3) of the solar cell module 10 is the smallest tilted angle and the light collection efficiency can be maximized.

As time passes further, the sun moves to the southwest and the altitude of the solar cell module 10 is lowered. Correspondingly, the first driving motor (M1) rotates the solar cell module 10 toward the southwest.

Reflecting the lowered altitude, the first supporting unit 120 engaging with one end of the transfer member 303 is rotated to form a larger tilted angle.

As the time passes further to sunset, the sun is located in the west and the altitude of the solar cell module 10 is lowered more.

Reflecting the more lowered altitude, the first driving motor (M1) rotates the solar cell module 10 toward the west.

Reflecting the altitude of the sun in that state, one end of the transfer member 303 is moved upward as far as possible and rotated to increase the tilted angle of the first supporting unit 120.

Accordingly, the arrangement angle of the solar cell module 10 is the largest tilted angle. After sunset, the photovoltaic power generation device 100 is rotated toward the east before sunrise of the next day to collect lights at sunrise of the next day again.

Accordingly, the photovoltaic power generation device 100 according to the present invention can be automatically rotated according to variations of sun altitude and sun azimuth in process of time to maximize the light collection efficiency. Also, the photovoltaic power generation device 100 according to the present invention can have an effect of adjusting the altitude angle and azimuth for each of daily time periods and season periods, corresponding to variations of the sun altitude.

The control unit 500 can precisely control the altitude angle and azimuth, corresponding to the position of the sun advantageously.

In addition, the pressure applied by the wind or snow can be effectively dispersed by using the height difference and gap between the solar cell panels. The supporting frame 110 supporting the solar cell module 10 may be supported by the first supporting unit 120 and the hinge connection unit 140. Accordingly, deformation of the solar cell module 10 and the supporting frame 110 generated by an external force such as a strong wind can be prevented.

Finally, the lightening protection unit 400 is provided and lightening may be prevented from directly falling on the solar cell module 10. Accordingly, damage to the solar cell module 10 can be prevented advantageously.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

According to the photovoltaic power generation device, the arrangement angle and direction of the solar cell module can be adjusted according to the altitude and direction of the sun. In addition, the pressure applied to the solar cell panel by the snow or winds can be reduced. Accordingly, the limit of the local and environmental effect can be overcome and the photovoltaic power generation device according to the present invention can be applicable to various environments.

### FREE TEXT

100: Photovoltaic Power Generation Device 110: Supporting Frame
120: First Supporting Frame 140: Hinge Connection Unit
200: Horizontal Driving Unit 300: Vertical Driving Unit
400: Lightening Protection Unit 500: Control Unit
600: Case
10: Solar Cell Module

1. A photovoltaic power generation device comprising:
a supporting frame provided to make positions of a plurality of solar cell modules be adjustable;
a first supporting unit provided under the supporting frame to dispersedly support a load of the supporting frame;
a hinge connection unit coupled to a lower portion of the first supporting unit to relatively rotate the first supporting unit in a vertical direction;
a horizontal driving unit provided in a lower portion of the hinge connection unit, the horizontal driving unit comprising a first driving motor configured to rotate the hinge connection unit from the ground in a horizontal direction; and
a vertical driving unit comprising one end coupled to a lateral surface of the hinge connection unit and the other end coupled to a central portion of the first supporting unit.

2. The photovoltaic power generation device according to claim 1, wherein the vertical driving unit comprises,
a rotary member comprising one end coupled to the second driving motor to rotate together with the second driving motor, with a male screw formed in an outer circumferential surface thereof, formed in a longitudinal round bar shape;
a transfer member comprising one end rotatably coupled the first supporting unit, with a female screw engaging with the rotary member to reciprocate forward and backward along the rotation of the rotary member;
a guide member comprising a lower portion of an outer circumferential surface thereof rotatably coupled to a predetermined portion of the hinge connection unit, to guide the reciprocation of the transfer member.

3. The photovoltaic power generation device according to claim 2, wherein the transfer member comprises at least one first bush coupled to an outer circumferential surface of the other end thereof to contact with an inner circumferential surface of the guide member to prevent a frictional force and noise.

4. The photovoltaic power generation device according to claim 3, wherein the guide member comprises,
a second bush provided in an inner circumferential surface of one end thereof to face the first bush during the reciprocation of the transfer member to guide a moving direction of the transfer member and to restrict separation of the transfer member.

5. The photovoltaic power generation device according to claim 2, further comprising:
a decelerator disposed between the second driving motor and the rotary member to control a rotational force of the rotary member.

6. The photovoltaic power generation device according to claim 1, further comprising:
a control unit configured to control the first driving motor and the second driving motor to adjust an azimuth and an altitude of the solar cell modules.

7. The photovoltaic power generation device according to claim 6, wherein the control unit detects weather information provided outside or from a weather information detecting sensor provided therein and controls the first driving motor and the second driving motor based on the detected weather information.

8. The photovoltaic power generation device according to claim 6, wherein the control unit comprises,
a GPS module configured to receive a GPS signal from a satellite;
a communication module configured to group the plurality of the solar cell modules as one group by using RS 485 communication and to transmit sensing signal of the solar cell modules;
a weather module configured to receive the weather information acquired by the communication module or the GPS module and to analyze the weather information; and
a control module configured to control the first driving motor and the second driving motor based on the information transmitted from the weather module.

9. The photovoltaic power generation device according to claim 8, wherein the weather module determines whether the information transmitted from the GPS module or the communication module is corresponding to a yellow dust mode, a typhoon mode, a snow mode or a seasonal wind mode and transmits the result of the determination to the control module.

10. The photovoltaic power generation device according to claim 8, wherein the GPS module acquires information on a position of the solar cell modules and information on the current time and weather information on the temperature, the humidity and winds and transmits the acquired information to the control module via the weather module.

11. The photovoltaic power generation device according to claim 1, wherein the solar cell module comprises a plurality of solar cell panels arranged thereon, and
a fixing bracket fixing the solar cell panels to the supporting frame to make the height of one solar cell panel be different from the height of another neighboring solar cell panel.

12. The photovoltaic power generation device according to claim 11, wherein the solar cell panels are arranged on the solar cell modules, with the height of one solar cell panel being different from the height of another solar cell arranged next to one solar cell panel in right/left and up/down directions.

13. The photovoltaic power generation device according to claim 11, wherein the solar cell panels are arranged to have the same height with the other solar cell panels arranged on the solar cell modules in zigzags.

14. The photovoltaic power generation device according to claim 11, wherein the solar cell panels are arranged to form a gap between one solar cell panel and another solar cell panel arranged next to one solar cell panel in right/left and up/down directions on the solar cell modules.

15. The photovoltaic power generation device according to claim 1, further comprising:
a lightening protection unit arranged in a predetermined position that is higher than a top surface of the solar cell module to prevent a lightening from damaging to the solar cell modules.

16. The photovoltaic power generation device according to claim 15, wherein the lightening protection unit is arranged in a predetermined portion of the solar cell module that is the highest portion, and
the lightening protection unit comprises,
a plurality of coupling members coupled to an outer portion of the supporting frame;
a plurality of insulator members coupled to outer portions of the coupling members, respectively, the insulator members formed of an insulative material;
an extended member extended to have a larger height than the top surface of the solar cell module; and
a lightening inducement member formed of a metallic material inducing a lightening, the lightening inducement member connecting upper ends of the extended members with each other.

17. The photovoltaic power generation device according to claim 16, wherein the insulator member performs insulation between the coupling member and a lower end of the extended member and the insulation member comprises a corrugation configured to increase a surface distance of an outer circumferential surface and to prevent an insulation strength from deteriorated by an contaminated surface.

18. The photovoltaic power generation device according to claim 2, further comprising:
a control unit configured to control the first driving motor and the second driving motor to adjust an azimuth and an altitude of the solar cell modules.

19. The photovoltaic power generation device according to claim 3, further comprising:
a control unit configured to control the first driving motor and the second driving motor to adjust an azimuth and an altitude of the solar cell modules.

20. The photovoltaic power generation device according to claim 4, further comprising:
a control unit configured to control the first driving motor and the second driving motor to adjust an azimuth and an altitude of the solar cell modules.

21. The photovoltaic power generation device according to claim 5, further comprising:
a control unit configured to control the first driving motor and the second driving motor to adjust an azimuth and an altitude of the solar cell modules.
